(19) United States
(12) Patent Application Publication
(10) Pub. No.: US 2009/0303217 A1
(43) Pub. Date: Dec. 10, 2009

(54) TRANSMISSION INTERFACE FOR REDUCING POWER CONSUMPTION AND ELECTROMAGNETIC INTERFERENCE AND METHOD THEREOF

(75) Inventors: Min-Jung Chen, Changhua County (TW); Jen-Ta Yang, Hsinchu County (TW); Chien-Cheng Tu, Hsinchu City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: Novatek Microelectronics Corp., Hsinchu (TW)

(21) Appl. No.: 12/324,754

(22) Filed: Nov. 26, 2008

(30) Foreign Application Priority Data
Jun. 4, 2008 (TW) 97120791

(51) Int. Cl. G09G 5/00

(52) U.S. Cl. 345/211

(57) ABSTRACT

The exemplary examples of the present invention provide a transmission interface and method thereof for reducing power consumption and electromagnetic interference. The transmission interface is used in the Liquid Crystal Display (LCD), and the LCD has x source drivers. The i^{th} source driver processes kᵢ transmission signals, wherein kᵢ is a natural number larger than 1, x is a natural number, and i is an integer from 1 to x. The transmission interface includes an encoding device. The encoding device receives

$$( {\sum }_{i = 1}^{x} {k}_{i} )$$

image signals. Then, the encoding device sets the

$${[ ( {\sum }_{i = 1}^{j} {k}_{i} ) - {k}_{j} + 1 ]}^{th}$$

image signal as the

$${[ ( {\sum }_{i = 1}^{j} {k}_{i} ) - {k}_{j} + 1 ]}^{th}$$

transmission signal, and sets the differential value between the

$${[ ( {\sum }_{i = 1}^{j} {k}_{i} ) - {k}_{j} + {y}_{j} ]}^{th}$$

and the

$${[ ( {\sum }_{i = 1}^{j} {k}_{i} ) - {k}_{j} + {y}_{j} - 1 ]}^{th}$$

image signals as the

$${[ ( {\sum }_{i = 1}^{j} {k}_{i} ) - {k}_{j} + {y}_{j} ]}^{th}$$

transmission signal, wherein j is an integer from 1 to x, and yⱼ is an integer from 2 to kⱼ.

### CROSS-REFERENCE TO RELATED APPLICATION

This application claims the priority benefit of Taiwan application serial no. 97120791, filed on Jun. 4, 2008. The entirety of the above-mentioned patent application is hereby incorporated by reference herein and made a part of this specification.

### BACKGROUND OF THE INVENTION

1. Field of the Invention

The present invention relates to an internal transmission interface of a liquid crystal display (LCD) and method thereof and more particularly, to a transmission device for reducing power consumption and electromagnetic interference (EMI) and method thereof.

2. Description of Related Art

With the advancement in the fabrication technologies, thin LCDs have been widely used everywhere in daily life. Generally, there are a plurality of source drivers in an LCD, each of which is used to process a plurality of transmission signals (i.e. each source driver comprises a plurality of channels). Then, each source driver transmits the processed transmission signals to the LCD panel, thereby generating images.

Referring to FIG. 1, FIG. 1 is an internal circuit diagram of a conventional LCD device 10. The LCD device 10 comprises a timing controller 110, an LCD panel 120, a plurality of source drivers 130, and a plurality of gate drivers 140. The LCD panel 120 is coupled to the plurality of source drivers 130 and the plurality of gate drivers 140. The timing controller 110 is coupled to the plurality of source drivers 130 and the plurality of gate drivers 140.

The timing controller 110 receives a plurality of image signals and generates a plurality of control signals for the plurality of source drivers 130 and the plurality of gate drivers 140. The source drivers 130 receive the plurality of transmission signals transmitted from the timing controller 110, wherein the plurality of transmission signals are equal to the plurality of image signals. Then, the gate drivers 140 and the source drivers 130 enable the LCD units inside the LCD panel 120 to emit light according to the plurality of control signals so as to generate images corresponding to the transmission signals. As described above, the LCD device 10 uses a conventional transmission interface in which the timing controller 110 simply transmits the image signals directly to each source driver 130. Thus, if the image signal values stay the same consecutively, problems such as EMI and high power consumption may occur.

Referring to FIG. 2, FIG. 2 is a schematic view of a gradient horizontal line 201 and values of a plurality of image signals 200 thereof. Suppose the resolution of the LCD panel 120 is 1024×768 pixels and each pixel is represented by 8 bits. Then, a gradient horizontal line 201 of gray scale values 0˜255 is as what is shown in FIG. 2 and values of the plurality of image signals 200 are also as shown in FIG. 2. Each gray scale value is represented by four consecutive image signals. In the conventional transmission interface, the plurality of image signals 200 are simply transmitted directly to each source driver as a plurality of transmission signals.

Suppose there are 8 source drivers, and each of which processes 128 image signals 200. Then, the j^{th} source driver processes the image signal 200 of gray scale values [32·(j−1)]˜(32·j−1), wherein j is an integer between 1 and 8. After the image signals 200 of an entire gradient horizontal line have been transmitted to the source driver 130, being incorporated with the control of the gate driver 140, an entire gradient horizontal line may be displayed on the LCD. A whole image picture may be displayed with 768 repetitions of such an operation.

In summary, when a conventional LCD transmits an image picture, the image signals at various points are directly set as transmission signals for transmission regardless of the transmission interface. Even if the image consists of continuous and identical image signals, each image signal is required to be completely re-transmitted. As a result, the conventional transmission interface may easily lead to serious EMI, resulting in transmission error. In addition, re-transmission of identical image signals results in excessive power consumption, which fails to follow the current trend in electronic products of low power consumption.

### SUMMARY OF THE INVENTION

The exemplary examples of the present invention provide a transmission interface and method thereof which is applicable in an LCD and reduces power consumption and EMI. The transmission interface and method thereof take advantage of the continuity of the picture data and transmits the differential values of image signals between neighboring points instead of transmitting the image signals at each point, thereby reducing power consumption and EMI effects during transmission.

The exemplary example of the present invention provides a transmission interface which is applicable in an LCD and reduces power consumption and EMI. The LCD comprises x source drivers. The i^{th} source driver processes kᵢ transmission signals, wherein kᵢ is a natural number larger than 1, x is a natural number, and i is an integer from 1 to x. The transmission interface comprises an encoding device which receives

$$( {\sum }_{i = 1}^{x} {k}_{i} )$$

image signals. Then, the encoding device sets the

$${[ ( {\sum }_{i = 1}^{j} {k}_{i} ) - {k}_{j} + 1 ]}^{th}$$

image signal as the

$${[ ( {\sum }_{i = 1}^{j} {k}_{i} ) - {k}_{j} + 1 ]}^{th}$$

transmission signal, and sets the differential value between the

$${[ ( {\sum }_{i = 1}^{j} {k}_{i} ) - {k}_{j} + {y}_{j} ]}^{th}$$

and the

$${[ ( {\sum }_{i = 1}^{j} {k}_{i} ) - {k}_{j} + {y}_{j} - 1 ]}^{th}$$

image signals as the

$${[ ( {\sum }_{i = 1}^{j} {k}_{i} ) - {k}_{j} + {y}_{j} ]}^{th}$$

transmission signal, wherein j is an integer from 1 to x, and yⱼ is an integer from 2 to kⱼ.

According to the exemplary example of the present invention, the abovementioned transmission interface further comprises a decoding device which is coupled to the encoding device. The decoding device is used to decode the

$$( {\sum }_{i = 1}^{x} {k}_{i} )$$

transmission signals output from the encoding device and to transmit the

$${[ ( {\sum }_{i = 1}^{j} {k}_{i} ) - {k}_{j} + 1 ]}^{th} to {( {\sum }_{i = 1}^{j} {k}_{i} )}^{th}$$

transmission signals after decoding to the j^{th} source driver. The value of the

$${[ ( {\sum }_{i = 1}^{j} {k}_{i} ) - {k}_{j} + 1 ]}^{th}$$

transmission signal after decoding remains unchanged and the decoded value of the

$${[ ( {\sum }_{i = 1}^{j} {k}_{i} ) - {k}_{j} + {y}_{j} ]}^{th}$$

transmission signal becomes the sum of the

$${[ ( {\sum }_{i = 1}^{j} {k}_{i} ) - {k}_{j} + 1 ]}^{th}$$

to the

$${[ ( {\sum }_{i = 1}^{j} {k}_{i} ) - {k}_{j} + {y}_{j} ]}^{th}$$

transmission signals.

According to the exemplary example of the present invention, the abovementioned transmission interface further comprises x decoding devices which are coupled to the encoding device. The j^{th} decoding device is used to decode the

$${[ ( {\sum }_{i = 1}^{j} {k}_{i} ) - {k}_{j} + 1 ]}^{th}$$

to the

$${( {\sum }_{i = 1}^{j} {k}_{i} )}^{th}$$

transmission signals and to transmit the

$${[ ( {\sum }_{i = 1}^{j} {k}_{i} ) - {k}_{j} + 1 ]}^{th}$$

to

$${( {\sum }_{i = 1}^{j} {k}_{i} )}^{th}$$

transmission signals after decoding to the j^{th} source driver. The value of the

$${[ ( {\sum }_{i = 1}^{j} {k}_{i} ) - {k}_{j} + 1 ]}^{th}$$

transmission signal after decoding remains unchanged and the decoded value of the

$${[ ( {\sum }_{i = 1}^{j} {k}_{i} ) - {k}_{j} + {y}_{j} ]}^{th}$$

transmission signal becomes the sum of the

$${[ ( {\sum }_{i = 1}^{j} {k}_{i} ) - {k}_{j} + 1 ]}^{th}$$

to the

$${[ ( {\sum }_{i = 1}^{j} {k}_{i} ) - {k}_{j} + {y}_{j} ]}^{th}$$

transmission signals.

According to the exemplary example of the present invention, the number of bits of the abovementioned transmission signals and the number of bits of the image signals are the same. When the differential value between the

$${[ ( {\sum }_{i = 1}^{j} {k}_{i} ) - {k}_{j} + {y}_{j} ]}^{th}$$

image signal and the

$${[ ( {\sum }_{i = 1}^{j} {k}_{i} ) - {k}_{j} + {y}_{j} - 1 ]}^{th}$$

image signal is a negative value, the

$${[ ( {\sum }_{i = 1}^{j} {k}_{i} ) - {k}_{j} + {y}_{j} ]}^{th}$$

transmission signal uses a 2's complement of the differential value to represent each bit thereof.

The exemplary example of the present invention provides a transmission method which is applicable in an LCD and reduces power consumption as well as EMI. The LCD comprises x source drivers. The i^{th} source driver processes kᵢ transmission signals, wherein kᵢ is a natural number larger than 1, x is a natural number, and i is an integer from 1 to x. The transmission method comprises the following steps: (a) receiving

$$( {\sum }_{i = 1}^{x} {k}_{i} )$$

image signals; (b) setting the

$${[ ( {\sum }_{i = 1}^{j} {k}_{i} ) - {k}_{j} + 1 ]}^{th}$$

image signal as the

$${[ ( {\sum }_{i = 1}^{j} {k}_{i} ) - {k}_{j} + 1 ]}^{th}$$

transmission signal, wherein j is an integer from 1 to x; (c) setting the differential value between the

$${[ ( {\sum }_{i = 1}^{j} {k}_{i} ) - {k}_{j} + {y}_{j} ]}^{th}$$

image signal and the

$${[ ( {\sum }_{i = 1}^{j} {k}_{i} ) - {k}_{j} + {y}_{j} - 1 ]}^{th}$$

image signal as the

$${[ ( {\sum }_{i = 1}^{j} {k}_{i} ) - {k}_{j} + {y}_{j} ]}^{th}$$

transmission signal, wherein yⱼ is an integer from 2 to kⱼ.

According to the exemplary example of the present invention, the above transmission method further comprises the following step: (d) decoding the

$$( {\sum }_{i = 1}^{x} {k}_{i} )$$

transmission signals and transmitting the

$${[ ( {\sum }_{i = 1}^{j} {k}_{i} ) - {k}_{j} + 1 ]}^{th}$$

to the

$${( {\sum }_{i = 1}^{j} {k}_{i} )}^{th}$$

transmission signals after decoding to the j^{th} source driver, wherein the value of the

$${[ ( {\sum }_{i = 1}^{j} {k}_{i} ) - {k}_{j} + 1 ]}^{th}$$

transmission signal remains unchanged after decoding and the value of the

$${[ ( {\sum }_{i = 1}^{j} {k}_{i} ) - {k}_{j} + {y}_{j} ]}^{th}$$

transmission signal after decoding becomes the sum of the

$${[ ( {\sum }_{i = 1}^{j} {k}_{i} ) - {k}_{j} + 1 ]}^{th}$$

to the

$${[ ( {\sum }_{i = 1}^{j} {k}_{i} ) - {k}_{j} + {y}_{j} ]}^{th}$$

transmission signals.

According to the exemplary example of the present invention, the number of bits of the abovementioned transmission signals and the number of bits of the image signals are the same. When the differential value between the

$${[ ( {\sum }_{i = 1}^{j} {k}_{i} ) - {k}_{j} + {y}_{j} ]}^{th}$$

image signal and the

$${[ ( {\sum }_{i = 1}^{j} {k}_{i} ) - {k}_{j} + {y}_{j} - 1 ]}^{th}$$

image signal is a negative value, the

$${[ ( {\sum }_{i = 1}^{j} {k}_{i} ) - {k}_{j} + {y}_{j} ]}^{th}$$

transmission signal uses a 2's complement of the differential value to represent each bit thereof.

The exemplary example of the present invention further provides another transmission interface applicable in an LCD. The LCD comprises at least a source driver and the transmission interface comprises an encoding device. The source driver is used to process x transmission signals, wherein x is an integer larger than 1. The encoding device receives x image signals, encodes the first image signal of the x image signals as the first transmission signal, and encodes the differential value between the y^{th} image signal and the (y−1)^{th} image signal of the x image signals as the y^{th} transmission signal, so as to generate x transmission signals, wherein y is an integer from 2 to x.

According to the exemplary example of the present invention, the abovementioned transmission interface further comprises a decoding device. The decoding device is coupled to the encoding device for decoding the x transmission signals received from the encoding device and transmitting the x transmission signals to the source driver.

According to the exemplary example of the present invention, the number of bits of the abovementioned transmission signals and the number of bits of the image signals are the same. When the differential value between the y^{th} image signal and the (y−1)^{th} image signal is a negative value, the y^{th} transmission signal uses a 2's complement of the differential value to represent each bit thereof.

The exemplary example of the present invention further provides another transmission method applicable in an LCD. The LCD comprises at least a source driver used to process x transmission signals, wherein x is an integer larger than 1. The transmission method comprises the following steps: (1) receiving x image signals; (2) encoding the first image signal of the x image signals as the first transmission signal; (3) encoding the differential value between the y^{th} image signal and the (y−1)^{th} image signal of the x image signals as the y^{th} transmission signal, wherein y is an integer from 2 to x.

According to the exemplary example of the present invention, the above transmission method further comprises the following step: (4) decoding the x transmission signals and transmitting the x transmission signals to the source driver after decoding.

According to the exemplary example of the present invention, the number of bits of the abovementioned transmission signals and the number of bits of the image signals are the same. When the differential value between the y^{th} image signal and the (y−1)^{th} image signal is a negative value, the y^{th} transmission signal uses a 2's complement of the differential value to represent each bit thereof.

The exemplary example of the present invention further provides another transmission method applicable in an LCD. The LCD comprises at least one source driver, processing at least two transmission signals, and the transmission interface. First, at least two image signals are received. The first image signal of the two image signals is encoded as the first transmission signal of the two transmission signals. Then, the differential value between the first image signal and the second image signal of the two image signals is encoded as the second transmission signal of the two transmission signals.

The transmission interface and method thereof take advantage of the continuity of the picture data and transmit the differential values of image signals between neighboring points instead of transmitting the image signals at each point, thereby reducing power consumption and EMI effects during transmission. Therefore, compared with the conventional transmission interface and method, the exemplary examples of the present invention provide a transmission interface and method with advantages such as low power consumption and low EMI.

In order to make the aforementioned and other features and advantages of the present invention more comprehensible, embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is an internal circuit diagram of a conventional LCD device 10.

FIG. 2 is a schematic view of a gradient horizontal line 201 and values of a plurality of image signals 200 thereof.

FIG. 3A is a schematic view of a plurality of transmission signals when a conventional transmission interface is used to transmit a gradient horizontal line.

FIG. 3B is a schematic view of a plurality of transmission signals when a transmission interface provided in the exemplary example of the present invention is used to transmit a gradient horizontal line.

FIG. 3C is a concept schematic diagram of the calculation of a plurality of red transmission signals 310 in the exemplary example shown in FIG. 3B.

FIG. 4A is a schematic view of a gray scale gradient horizontal line 400.

FIG. 4B is a schematic view of a plurality of image signals of the gray scale gradient horizontal line 400.

FIG. 4C is a schematic diagram of a plurality of red transmission signals 420 of the transmission interface according to the exemplary example of the present invention.

FIG. 5A is a block diagram of a transmission interface 560 provided in the exemplary example of the present invention and applied in an LCD device 50.

FIG. 5B is a block diagram of a transmission interface 565 provided by another exemplary example of the present invention and applied in an LCD device 52.

FIG. 5C is a block diagram of a transmission interface 570 provided by another exemplary example of the present invention and applied in an LCD device 51.

FIG. 6 is a flow chart of the steps of a transmission method provided in the exemplary example of the present invention.

FIG. 7A is a waveform diagram of image signals of an LCD device adopting a multi-point low differential signal interface.

FIG. 7B is a waveform diagram of transmission signals when a conventional transmission interface is used to transmit the image signals of FIG. 7A.

FIG. 7C is a waveform diagram of transmission signals when a transmission interface provided in the exemplary example of the present invention is used to transmit the image signals of FIG. 7A.

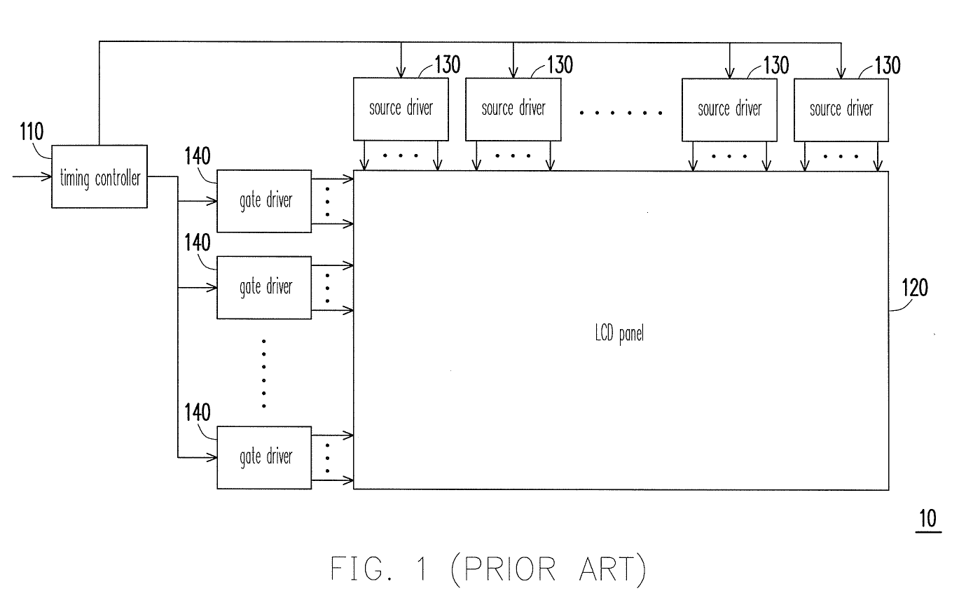

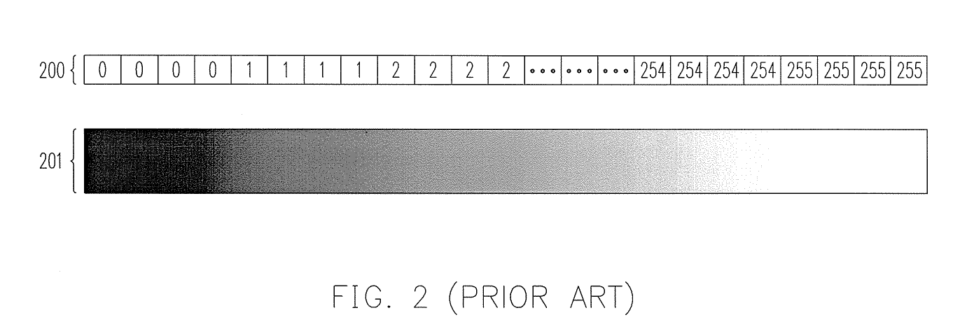

### DESCRIPTION OF EMBODIMENTS

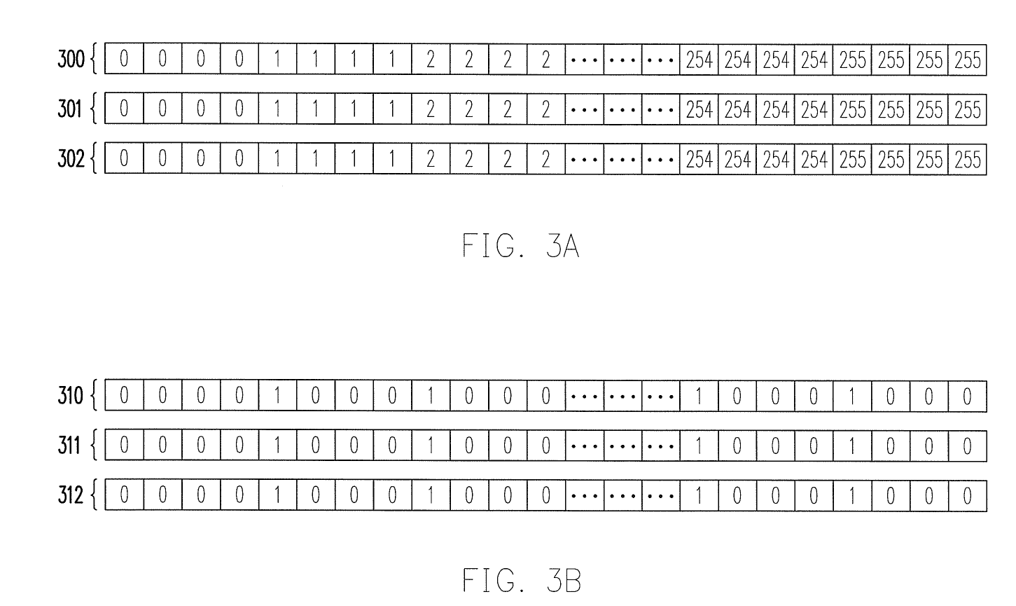

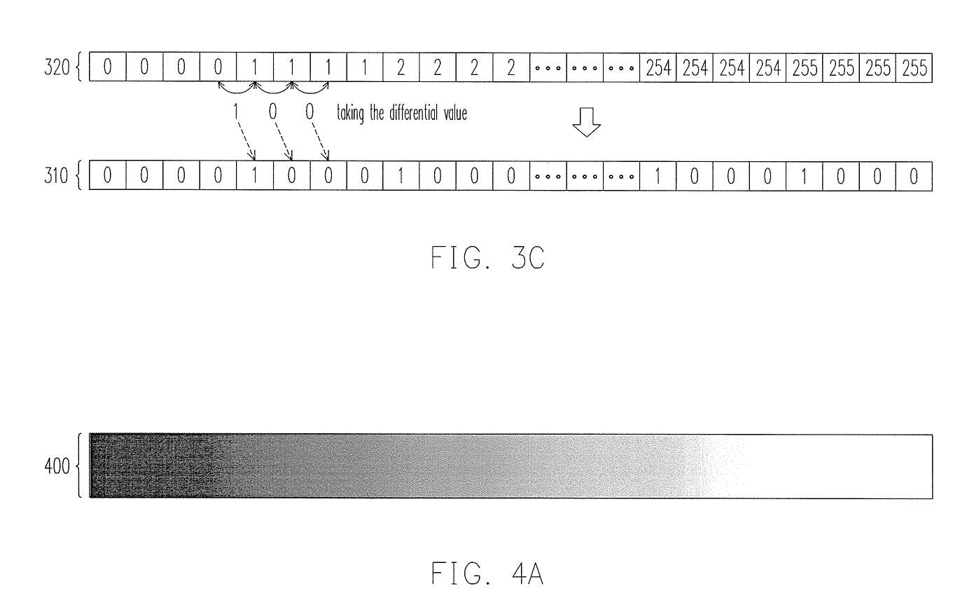

Referring to FIG. 3A˜3C, FIG. 3A is a schematic view of a plurality of transmission signals when a conventional transmission interface is used to transmit a gradient horizontal line. FIG. 3B is a schematic view of a plurality of transmission signals when a transmission interface provided in the exemplary example of the present invention is used to transmit a gradient horizontal line. FIG. 3C is a concept schematic diagram of the calculation of a plurality of red transmission signals 310 in the exemplary example shown in FIG. 3B. FIGS. 3A and 3B are the situations under the assumption that a source driver may process 1024 transmission signals (i.e. a source driver has 1024*3 channels). The gray scale values of the gradient horizontal line are 0 to 255. The image signal at each point includes a red image signal, a green image signal, and a blue image signal. Thus, the values of the red image signal, green image signal, and blue image signal are a sequence of {0,0,0,0,1,1,1,1, . . . ,255,255,255,255}. In addition, the transmission signal at each point includes a red transmission signal, a green transmission signal, and a blue transmission signal.

If a conventional transmission interface is used to transmit the abovementioned image signals of the gradient horizontal line, the transmission signals transmitted to the source driver are as shown in FIG. 3A. The values of the red, green, and blue transmission signals 300-302 will be the same as those of the original red, green, and blue image signals, respectively. That is, they all are a sequence of {0,0,0,0,1,1,1,1, . . . ,255,255,255,255}. Therefore, when transmitting continuous image signals using the conventional interface, problems mentioned in the Description of Related Art may occur.

If the transmission interface provided in the exemplary example of the present invention is used, the transmission signals transmitted to the source driver are as shown in FIG. 3B and FIG. 3C. Because the image signals are continuous, the value of the first red transmission signal 310 is 0 and the value of the subsequent k^{th} red transmission signal 310 is the differential value between the k^{th} red image signal 320 and the (k−1)^{th} red image signal 320. In addition, the values of the green transmission signals 311 and the blue transmission signals 312 may be deduced in the same manner. In this exemplary example, the values of the red, green, and blue transmission signals 310˜312 area sequence of {0,0,0,0,1,0,0,0,1, . . . ,1,0,0,0}.

However, an LCD may include a plurality of source drivers. For example, an LCD may include 8 source drivers which can process 384 channels. Each source driver may process 128 transmission signals, each of which includes a red, green, and blue transmission signal.

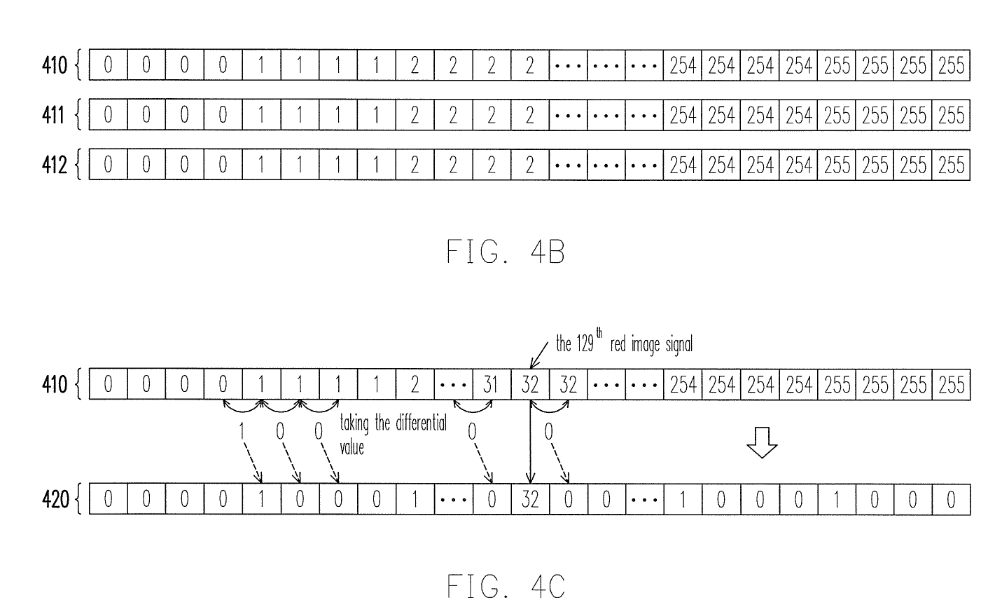

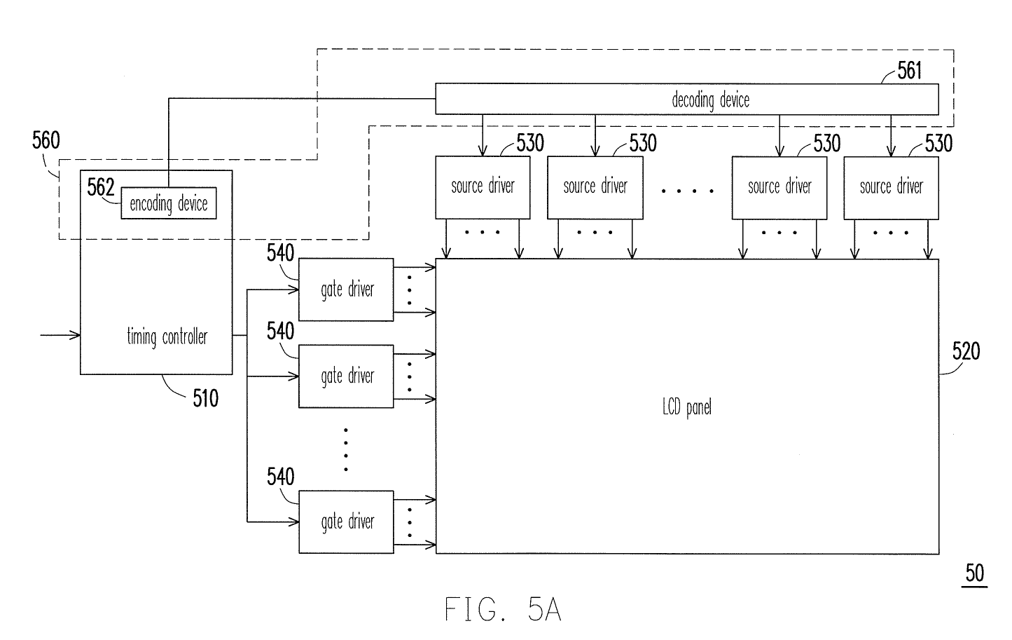

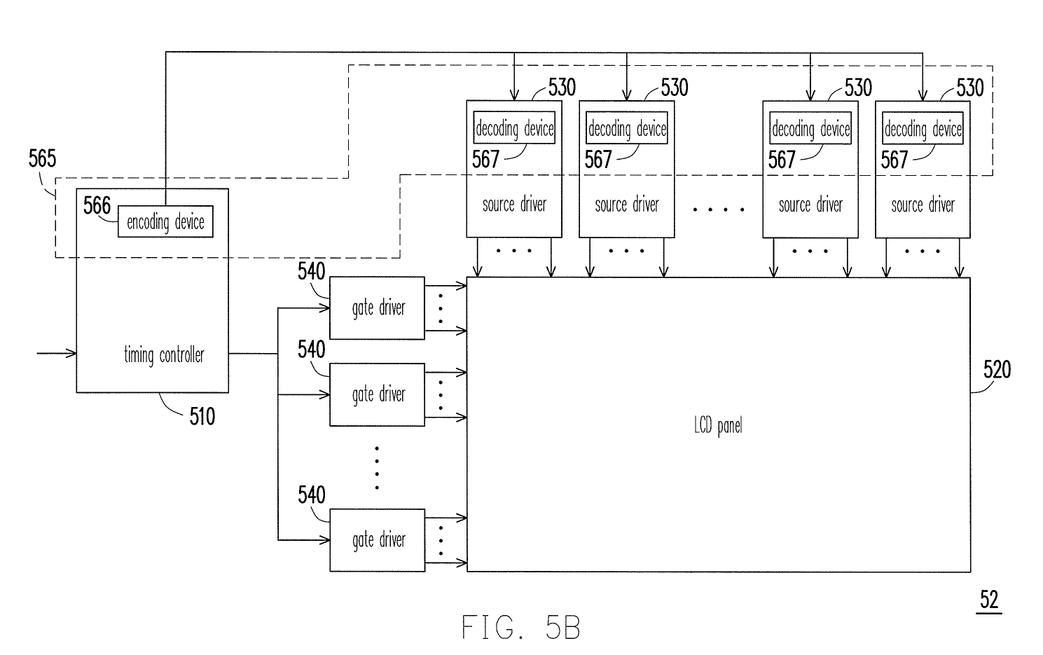

Referring to FIGS. 4A˜4C, FIG. 4A is a schematic view of a gray scale gradient horizontal line 400. FIG. 4B is a schematic view of a plurality of image signals of the gray scale gradient horizontal line 400. FIG. 4C is a schematic diagram of a plurality of red transmission signals 420 of a transmission interface provided in the exemplary example of the present invention. The gradient horizontal line 400 is a gray scale gradient horizontal line 400 of values 0˜255, of which the values of the plurality of image signals are shown in FIG. 4B. The values of the plurality of red image signals 410, the plurality of green image signals 411, and the plurality of blue image signals 412 are all sequences of {0,0,0,0,1,1,1,1, . . . ,255,255,255,255}.

Suppose the transmission interface provided by the present example is used in an LCD having eight source drivers and each source driver is capable of processing 128 transmission signals (i.e. having 384 channels). In other words, the p^{th} source driver receives the [128·(p−1)+1]^{th} to the (128·p)^{th} transmission signals, wherein p is an integer from 1 to 8.

According to the above assumption, the transmission signals used in the transmission interface provided in the exemplary example of the present invention are as shown in FIG. 4C. It should be noted that the transmission signals of the present invention are transmitted as the differential values of the image signals. Thus, for each source driver, the first signal received by each source driver has to be an initial value so that the following signals may be represented by the differential values.

Therefore, the [128·(p−1)+1]^{th} red transmission signal 420 and the [128·(p−1)+1]^{th} red image signal 410 are the same and the [128·(p−1)+y]^{th} red transmission signal 420 is the differential value between the [128·(p−1)+y]^{th} red image signal 410 and the [128·(p−1)+y−1]^{th} red image signal 410, wherein y is an integer from 2 to 128.

For example, continuously referring to FIG. 4C, according to the above equation, the 129^{th} red transmission signal 420 and the 129^{th} red image signal 410 are the same. This is because each source driver processes only 128 transmission signals. The 129^{th} red transmission signal 420 is processed by a second source driver. In addition, the values of the green transmission signals and the blue transmission signals may be deduced in the same manner, which will not be further described herein.

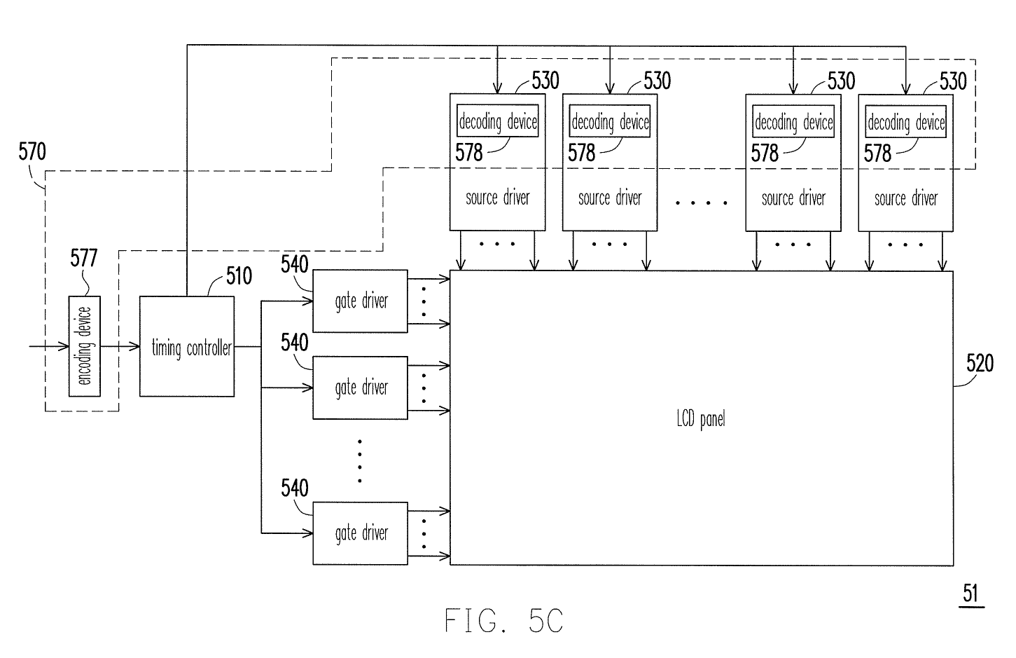

Next, referring to FIG. 5A, FIG. 5A is a block diagram of a transmission interface 560 provided by the exemplary example of the present invention and applied in an LCD device 50. The transmission interface 560 comprises an encoding device 562 and a decoding device 561. The encoding device 562 is between a timing controller 510 and a plurality of source drivers 530. The decoding device 561 is between the plurality of source drivers 530 and the timing controller 510. In the present exemplary example, the encoding device 562 is included in the timing controller 510.

The LCD device 50 comprises x source drivers 530, wherein the i^{th} source driver processes kᵢ transmission signals, kᵢ is a natural number larger than 1, x is a natural number, and i is an integer from 1 to x. The encoding device 562 receives

$$( {\sum }_{i = 1}^{x} {k}_{i} )$$

image signals from the timing controller 510. Then, the encoding device 562 sets the

$${[ ( {\sum }_{i = 1}^{j} {k}_{i} ) - {k}_{j} + 1 ]}^{th}$$

image signal as the

$${[ ( {\sum }_{i = 1}^{j} {k}_{i} ) - {k}_{j} + 1 ]}^{th}$$

transmission signal and sets the differential value between the

$${[ ( {\sum }_{i = 1}^{j} {k}_{i} ) - {k}_{j} + {y}_{j} ]}^{th}$$

and the

$${[ ( {\sum }_{i = 1}^{j} {k}_{i} ) - {k}_{j} + {y}_{j} - 1 ]}^{th}$$

image signals as the

$${[ ( {\sum }_{i = 1}^{j} {k}_{i} ) - {k}_{j} + {y}_{j} ]}^{th}$$

transmission signal, wherein j is an integer from 1 to x, and yⱼ is an integer from 2 to kⱼ.

The decoding device 561 is used to decode the

$$( {\sum }_{i = 1}^{x} {k}_{i} )$$

transmission signals output from the encoding device 562 and to transmit the

$${[ ( {\sum }_{i = 1}^{j} {k}_{i} ) - {k}_{j} + 1 ]}^{th}$$

to

$${[ ( {\sum }_{i = 1}^{j} {k}_{i} ) ]}^{th}$$

transmission signals after decoding to the j^{th} source driver. The value of the

$${[ ( {\sum }_{i = 1}^{j} {k}_{i} ) - {k}_{j} + 1 ]}^{th}$$

transmission signal after decoding remains unchanged and the decoded value of the

$${[ ( {\sum }_{i = 1}^{j} {k}_{i} ) - {k}_{j} + {y}_{j} ]}^{th}$$

transmission signal becomes the sum of the

$${[ ( {\sum }_{i = 1}^{j} {k}_{i} ) - {k}_{j} + 1 ]}^{th}$$

to the

$${[ ( {\sum }_{i = 1}^{j} {k}_{i} ) - {k}_{j} + {y}_{j} ]}^{th}$$

transmission signals.

Generally, each source driver 530 processes the same number of transmission signals. In other words, kᵢ is equal to k_{i′+1} and i′ is an integer from 1 to (x−1). However, the transmission interface 560 provided in the exemplary example of the present invention is not limited to the case in which each source driver processes the same number of transmission signals.

Furthermore, as described above, each image signal includes red, green, and blue image signals and each transmission signal includes red, green, and blue image signals.

The case in which each source driver 530 processes the same number of transmission signals has been shown in FIG. 4A˜4C. Another exemplary example in which two source drivers 530 process different number of transmission signals is illustrated below. Suppose the LCD device 50 has two source drivers and a plurality of image signals of a horizontal line are to be transmitted. The plurality of red image signals of the image signals are a sequence of {1,2,2,2,3,3,3,3}, the plurality of green image signals are a sequence of {0,0,0,2,2,2,2,2}, and the plurality of blue image signals are a sequence of {5,7,7,7,7,7,8,8}.

If the first source driver 530 may process 5 transmission signals and the second source driver 530 may process 3 transmission signals.

The first red transmission signal to the fifth red transmission signal are a sequence of {1,1,0,0,1} and the sixth red transmission signal to the eighth red transmission signal are a sequence of {3,0,0}. The first red transmission signal to the fifth red transmission signal are processed by the first source driver 530 and the sixth red transmission signal to the eighth red transmission signal are processed by the second source driver 530.

The first green transmission signal to the fifth green transmission signal are a sequence of {0,0,0,2,0} and the sixth green transmission signal to the eighth green transmission signal are a sequence of {2,0,0}. The first green transmission signal to the fifth green transmission signal are processed by the first source driver 530 and the sixth green transmission signal to the eighth green transmission signal are processed by the second source driver 530.

The first blue transmission signal to the fifth blue transmission signal are a sequence of {5,2,0,0,0} and the sixth blue transmission signal to the eighth blue transmission signal are a sequence of {7,1,0}. The first blue transmission signal to the fifth blue transmission signal are processed by the first source driver 530 and the sixth blue transmission signal to the eighth blue transmission signal are processed by the second source driver 530.

In the above exemplary example, the first red transmission signal to the fifth red transmission signal are a sequence of {1,1,0,0,1}. When decoding, except for that the first red image signal is equal to the first red transmission signal, the rest of the red image signals are the accumulated values of their preceding red transmission signals. Thus, the first red transmission signal to the fifth red transmission signal become a sequence of {1,2,2,2,3} after decoding and the first red transmission signal to the fifth red transmission signal after decoding are the same as the first red image signal to the fifth red image signal.

The sixth red transmission signal to the eighth red transmission signal are a sequence of {3,0,0}. Therefore, when decoding, except for that the sixth red image signal is equal to the sixth red transmission signal, the rest of the red image signals are the accumulated values of their preceding red transmission signals. Thus, the sixth red transmission signal to the eighth red transmission signal become a sequence of {3,0,0} after decoding and the sixth red transmission signal to the eighth red transmission signal after decoding are the same as the sixth red image signal to the eighth red image signal. In addition, the same manners are applicable for the green transmission signals and the blue transmission signals, which will not be further described herein.

It should be noted that the number of bits of the transmission signals and the number of bits of the image signals are the same. When the differential value between the

$${[ ( {\sum }_{i = 1}^{j} {k}_{i} ) - {k}_{j} + {y}_{j} ]}^{th}$$

image signal and the

$${[ ( {\sum }_{i = 1}^{j} {k}_{i} ) - {k}_{j} + {y}_{j} - 1 ]}^{th}$$

image signal is a negative value, the

$${[ ( {\sum }_{i = 1}^{j} {k}_{i} ) - {k}_{j} + {y}_{j} ]}^{th}$$

transmission signal uses a 2's complement of the differential value to represent each bit thereof.

Two neighboring image signals may be from high gray scale to low gray scale or from low gray scale to high gray scale so the variation range is from −255 to 255. Suppose image signals of 8 bits are used for transmission. The values of the image signals are 0˜255 so the differential values may be directly transmitted from low gray scale to high gray scale. However, from high gray scale to low gray scale, in order to accurately transmit the transmission signals without increasing the number of bits, 2's complements of the negative differential values are adopted to solve this problem.

For example, if the differential value between two image signals is −127, then the value 129 is transmitted. Represented with a binary number, 127 is {0111 1111} and its 2's complement is {1000 0001}, i.e. 129. The decoding device 561 adds the values 127 and 129, takes the lowest 8 bits, discards the bits in excess of 8, and obtains the image signal with value 0. Represented with a binary number, the result of adding {0111 1111} and {1000 0001} is {1 0000 0000}. Take the 8 least significant bits and the result is 0. Therefore, if the differential value between signals is negative, a correct image signal may be decoded by transmitting a 2's complement value.

Next, referring to FIG. 5B, FIG. 5B is a block diagram of a transmission interface 565 provided by another exemplary example of the present invention and applied in an LCD device 52. In this exemplary example, the encoding device 566 is still included in the timing controller 510 and the decoding device 567 is included in the source driver 530. The j^{th} decoding device 567 is used to decode the

$${[ ( {\sum }_{i = 1}^{j} {k}_{i} ) - {k}_{j} + 1 ]}^{th}$$

to the

$${[ ( {\sum }_{i = 1}^{j} {k}_{i} ) ]}^{th}$$

transmission signals output from the encoding device 562 and to transmit the

$${[ ( {\sum }_{i = 1}^{j} {k}_{i} ) - {k}_{j} + 1 ]}^{th}$$

to

$${[ ( {\sum }_{i = 1}^{j} {k}_{i} ) ]}^{th}$$

transmission signals after decoding to the j^{th} source driver. The value of the

$${[ ( {\sum }_{i = 1}^{j} {k}_{i} ) - {k}_{j} + 1 ]}^{th}$$

transmission signal after decoding remains unchanged and the decoded value of the

$${[ ( {\sum }_{i = 1}^{j} {k}_{i} ) - {k}_{j} + {y}_{j} ]}^{th}$$

transmission signal becomes the sum of the

$${[ ( {\sum }_{i = 1}^{j} {k}_{i} ) - {k}_{j} + 1 ]}^{th}$$

to the

$${[ ( {\sum }_{i = 1}^{j} {k}_{i} ) - {k}_{j} + {y}_{j} ]}^{th}$$

transmission signals.

Next, referring to FIG. 5C, FIG. 5C is a block diagram of a transmission interface 570 provided by another exemplary example of the present invention and applied in an LCD device 51. The difference between FIG. 5C and FIG. 5B lies in that the encoding device 577 is placed before the timing controller 510 while the encoding device 566 is placed at the back end of the timing controller 510. Although the positions of the two encoding devices 577 and 566 are different, the principles are the same and will not be further described herein. In addition, the encoding device 577 may also be placed at the front end of the timing controller 510. Simply speaking, those of ordinary skill in the art may apply the transmission interface provided in the exemplary example of the present invention in an LCD device and the position of the elements of the interface may vary according to design requirement.

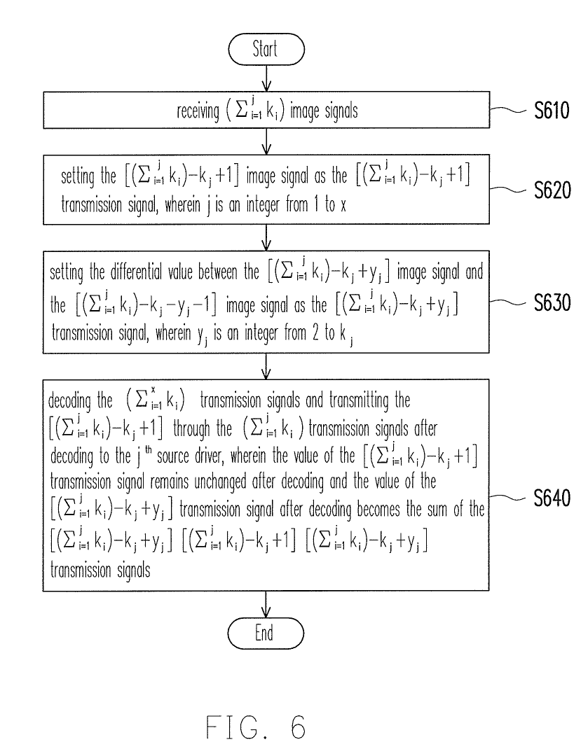

Next, referring to FIG. 6, FIG. 6 is a flow chart of the steps of a transmission method provided in the exemplary example of the present invention. The transmission method is used in an LCD which comprises x source drivers. The i^{th} source driver processes kᵢ transmission signals, wherein kᵢ is a natural number larger than 1, x is a natural number, and i is an integer from 1 to x. The transmission method comprises the following steps: (S610) receiving

$$( {\sum }_{i = 1}^{x} {k}_{i} )$$

image signals; (S620) setting the

$${[ ( {\sum }_{i = 1}^{j} {k}_{i} ) - {k}_{j} + 1 ]}^{th}$$

image signal as the

$${[ ( {\sum }_{i = 1}^{j} {k}_{i} ) - {k}_{j} + 1 ]}^{th}$$

transmission signal, wherein j is an integer from 1 to x; (S630) setting the differential value between the

$${[ ( {\sum }_{i = 1}^{j} {k}_{i} ) - {k}_{j} + {y}_{j} ]}^{th}$$

image signal and the

$${[ ( {\sum }_{i = 1}^{j} {k}_{i} ) - {k}_{j} + {y}_{j} - 1 ]}^{th}$$

image signal as the

$${[ ( {\sum }_{i = 1}^{j} {k}_{i} ) - {k}_{j} + {y}_{j} ]}^{th}$$

transmission signal, wherein yⱼ is an integer from 2 to kⱼ; (S640) decoding the

$$( {\sum }_{i = 1}^{x} {k}_{i} )$$

transmission signals and transmitting the

$${[ ( {\sum }_{i = 1}^{j} {k}_{i} ) - {k}_{j} + 1 ]}^{th}$$

to the

$${( {\sum }_{i = 1}^{j} {k}_{i} )}^{th}$$

transmission signals after decoding to the j^{th} source driver, wherein the value of the

$${[ ( {\sum }_{i = 1}^{j} {k}_{i} ) - {k}_{j} + 1 ]}^{th}$$

transmission signal remains unchanged after decoding and the value of the

$${[ ( {\sum }_{i = 1}^{j} {k}_{i} ) - {k}_{j} + {y}_{j} ]}^{th}$$

transmission signal after decoding becomes the sum of the

$${[ ( {\sum }_{i = 1}^{j} {k}_{i} ) - {k}_{j} + 1 ]}^{th}$$

to the

$${[ ( {\sum }_{i = 1}^{j} {k}_{i} ) - {k}_{j} + {y}_{j} ]}^{th}$$

transmission signals.

Certainly, the number of bits of the transmission signals and the number of bits of the image signals are the same. When the differential value between the

$${[ ( {\sum }_{i = 1}^{j} {k}_{i} ) - {k}_{j} + {y}_{j} ]}^{th}$$

image signal and the

$${[ ( {\sum }_{i = 1}^{j} {k}_{i} ) - {k}_{j} + {y}_{j} - 1 ]}^{th}$$

image signal is a negative value, the

$${[ ( {\sum }_{i = 1}^{j} {k}_{i} ) - {k}_{j} + {y}_{j} ]}^{th}$$

transmission signal uses a 2's complement of the differential value to represent each bit thereof.

In addition, the number of transmission signals processed by each source driver may be the same or different. Each image signal includes red, green, and blue image signals and each transmission signal includes red, green, and blue image signals.

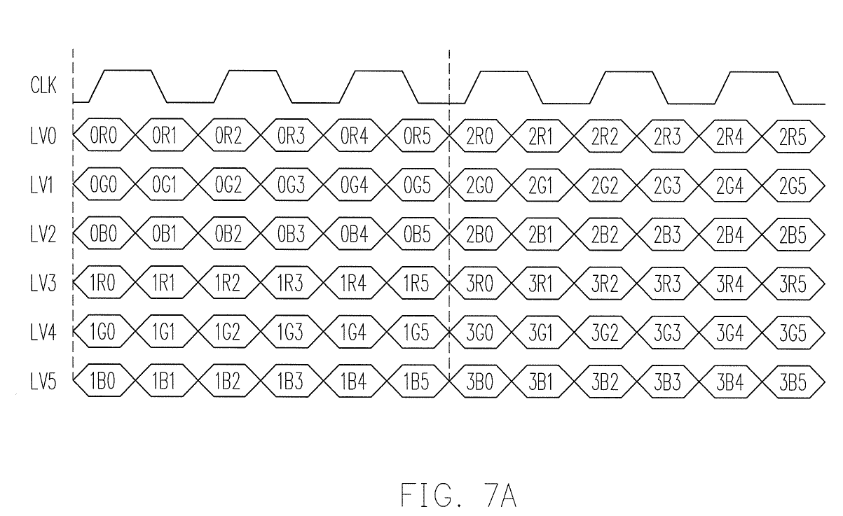

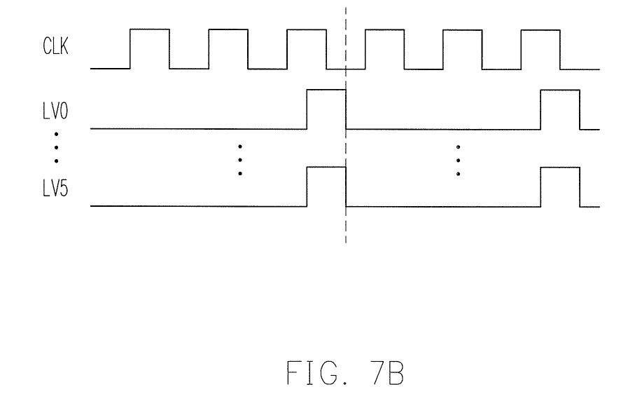

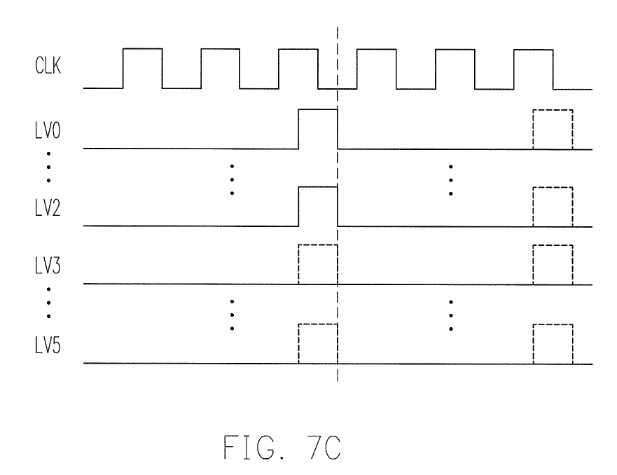

Next, referring to FIGS. 7A˜7C, FIG. 7A is a waveform diagram of image signals of an LCD adopting a multiple low voltage differential signaling (MLVDS) interface. FIG. 7B is a waveform diagram of transmission signals when a conventional transmission interface is used to transmit image signals of FIG. 7A. FIG. 7C is a waveform diagram of transmission signals when a transmission interface provided in the exemplary example of the present invention is used to transmit image signals of FIG. 7A.

FIG. 7A illustrates the case when 6 transmission lines, each of 6 bits, are used for transmission. A signal CLK represents a clock signal. A transmission line LV0 transmits the 6 bits 0R0˜0R5 of the first red image signal and the 6 bits 2R0˜2R5 of the third red image signal. A transmission line LV1 transmits the 6 bits 0G0˜0G5 of the first green image signal and the 6 bits 2G0˜2G5 of the third green image signal. A transmission line LV2 transmits the 6 bits 0B0˜0B5 of the first blue image signal and the 6 bits 2B0˜2B5 of the third blue image signal.

A transmission line LV3 transmits the 6 bits 1R0˜1R5 of the second red image signal and the 6 bits 3R0˜3R5 of the fourth red image signal. A transmission line LV4 transmits the 6 bits 1G0˜1G5 of the second green image signal and the 6 bits 3G0˜3G5 of the fourth green image signal. A transmission line LV5 transmits the 6 bits 1B0˜1B5 of the second blue image signal and the 6 bits 3B0˜3B5 of the fourth blue image signal.

Suppose each of the red, green, and blue image signals is 1. When a conventional transmission interface is used, the waveform diagram of the transmission signals in the transmission lines LV0˜LV5 are as shown in FIG. 7B. Each of the transmission lines LV0˜LV5 has to be toggled twice. Therefore, the transmission signals in the transmission lines LV0˜LV5 are toggled for a total of 12 times.

When the transmission interface of the exemplification of the present invention is used, the waveform diagram of the transmission signals in the transmission lines LV0˜LV5 are as shown in FIG. 7C. The transmission signals in the transmission lines LV0˜LV5 are toggled for a total of 3 times. Except for the first red, green, and blue transmission signals which are 1, the rest of the red, green, and blue transmission signals are 0. Hence, from the above exemplary example, the transmission interface provided in the one of the exemplary examples of the present invention has fewer toggles among the transmission signals and may reduce power consumption and EMI effects.

In summary, the transmission interface and method provided in the exemplary examples of the present invention take the advantage of the continuity commonly found in image signals. Except for certain pixels for which complete image signals need to be transmitted, for the rest of the pixels, the differential values between neighboring pixels are transmitted. As such, variations of the transmission signals on the data bus may be reduced and thus save power consumption and decrease EMI effects during transmission.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A transmission interface, used in an LCD, wherein the LCD comprises x source drivers, the i^{th} source driver processes kᵢ transmission signals, kᵢ is a natural number larger than 1, x is a natural number, i is an integer from 1 to x, and the transmission interface comprises:
an encoding device, receiving
$$( {\sum }_{i = 1}^{x} {k}_{i} )$$
image signals, setting the
$${[ ( {\sum }_{i = 1}^{j} {k}_{i} ) - {k}_{j} + 1 ]}^{th}$$
image signal as the
$${[ ( {\sum }_{i = 1}^{j} {k}_{i} ) - {k}_{j} + 1 ]}^{th}$$
transmission signal, and setting a differential value between the
$${[ ( {\sum }_{i = 1}^{j} {k}_{i} ) - {k}_{j} + {y}_{j} ]}^{th}$$
and the
$${[ ( {\sum }_{i = 1}^{j} {k}_{i} ) - {k}_{j} + {y}_{j} - 1 ]}^{th}$$
image signals as the
$${[ ( {\sum }_{i = 1}^{j} {k}_{i} ) - {k}_{j} + {y}_{j} ]}^{th}$$
transmission signal, j being an integer from 1 to x, yⱼ being an integer from 2 to kⱼ.

2. The transmission interface according to claim 1, further comprising:
a decoding device, coupled to the encoding device, used to receive the
$$( {\sum }_{i = 1}^{x} {k}_{i} )$$
transmission signals from the encoding device, to decode the
$$( {\sum }_{i = 1}^{x} {k}_{i} )$$
transmission signals, and to transmit the
$${[ ( {\sum }_{i = 1}^{j} {k}_{i} ) - {k}_{j} + 1 ]}^{th}$$
to
$${( {\sum }_{i = 1}^{j} {k}_{i} )}^{th}$$
transmission signals after decoding to the j^{th} source driver, wherein the value of the
$${[ ( {\sum }_{i = 1}^{j} {k}_{i} ) - {k}_{j} + 1 ]}^{th}$$
transmission signal after decoding remains unchanged and the decoded value of the
$${[ ( {\sum }_{i = 1}^{j} {k}_{i} ) - {k}_{j} + {y}_{j} ]}^{th}$$
transmission signal becomes the sum of the
$${[ ( {\sum }_{i = 1}^{j} {k}_{i} ) - {k}_{j} + 1 ]}^{th} to$$
the
$${[ ( {\sum }_{i = 1}^{j} {k}_{i} ) - {k}_{j} + {y}_{j} ]}^{th}$$
transmission signals.

3. The transmission interface according to claim 1, further comprising:
x decoding devices, coupled to the encoding device, wherein the j^{th} decoding device is used to decode the
$${[ ( {\sum }_{i = 1}^{j} {k}_{i} ) - {k}_{j} + 1 ]}^{th}$$
to the
$${( {\sum }_{i = 1}^{j} {k}_{i} )}^{th}$$
transmission signals and to transmit the
$${[ ( {\sum }_{i = 1}^{j} {k}_{i} ) - {k}_{j} + 1 ]}^{th}$$
to
$${( {\sum }_{i = 1}^{j} {k}_{i} )}^{th}$$
transmission signals after decoding to the j^{th} source driver, the value of the
$${[ ( {\sum }_{i = 1}^{j} {k}_{i} ) - {k}_{j} + 1 ]}^{th}$$
transmission signal after decoding remains unchanged, and the decoded value of the
$${[ ( {\sum }_{i = 1}^{j} {k}_{i} ) - {k}_{j} + {y}_{j} ]}^{th}$$
transmission signal becomes the sum of the
$${[ ( {\sum }_{i = 1}^{j} {k}_{i} ) - {k}_{j} + 1 ]}^{th}$$
to the
$${[ ( {\sum }_{i = 1}^{j} {k}_{i} ) - {k}_{j} + {y}_{j} ]}^{th}$$
transmission signals.

4. The transmission interface according to claim 1, wherein the number of bits of the transmission signals and the number of bits of the image signals are the same and when the differential value between the
$${[ ( {\sum }_{i = 1}^{j} {k}_{i} ) - {k}_{j} + {y}_{j} ]}^{th}$$
image signal and the
$${[ ( {\sum }_{i = 1}^{j} {k}_{i} ) - {k}_{j} + {y}_{j} - 1 ]}^{th}$$
image signal is a negative value, the
$${[ ( {\sum }_{i = 1}^{j} {k}_{i} ) - {k}_{j} + {y}_{j} ]}^{th}$$
transmission signal uses a 2's complement of the differential value to represent each bit thereof.

5. The transmission interface according to claim 1, wherein k_{i′} is equal to k_{i′+1} and i′ is an integer from 1 to (x−1).

6. The transmission interface according to claim 1, wherein each image signal comprises a red image signal, a green image signal, and a blue image signal, and each transmission signal comprises a red transmission signal, a green transmission signal, and a blue transmission signal.

7. A transmission method, used in an LCD, wherein the LCD comprises x source drivers, the i^{th} source driver processes kᵢ transmission signals, kᵢ is a natural number larger than 1, x is a natural number, i is an integer from 1 to x, and the transmission method comprises:
receiving
$$( {\sum }_{i = 1}^{x} {k}_{i} )$$
image signals;
setting the
$${[ ( {\sum }_{i = 1}^{j} {k}_{i} ) - {k}_{j} + 1 ]}^{th}$$
image signal as the
$${[ ( {\sum }_{i = 1}^{j} {k}_{i} ) - {k}_{j} + 1 ]}^{th}$$
transmission signal, wherein j is an integer from 1 to x; and
setting a differential value between the
$${[ ( {\sum }_{i = 1}^{j} {k}_{i} ) - {k}_{j} + {y}_{j} ]}^{th}$$
and the
$${[ ( {\sum }_{i = 1}^{j} {k}_{i} ) - {k}_{j} + {y}_{j} - 1 ]}^{th}$$
image signals as the
$${[ ( {\sum }_{i = 1}^{j} {k}_{i} ) - {k}_{j} + {y}_{j} ]}^{th}$$
transmission signal, yⱼ being an integer from 2 to kⱼ.

8. The transmission method according to claim 7, further comprising:
decoding the
$$( {\sum }_{i = 1}^{x} {k}_{i} )$$
transmission signals and transmitting the
$${[ ( {\sum }_{i = 1}^{j} {k}_{i} ) - {k}_{j} + 1 ]}^{th}$$
to
$${( {\sum }_{i = 1}^{j} {k}_{i} )}^{th}$$
transmission signals after decoding to the j^{th} source driver, wherein the value of the
$${[ ( {\sum }_{i = 1}^{j} {k}_{i} ) - {k}_{j} + 1 ]}^{th}$$
transmission signal after decoding remains unchanged and the decoded value of the
$${[ ( {\sum }_{i = 1}^{j} {k}_{i} ) - {k}_{j} + {y}_{j} ]}^{th}$$
transmission signal becomes the sum of the
$${[ ( {\sum }_{i = 1}^{j} {k}_{i} ) - {k}_{j} + 1 ]}^{th}$$
to the
$${[ ( {\sum }_{i = 1}^{j} {k}_{i} ) - {k}_{j} + {y}_{j} ]}^{th}$$
transmission signals.

9. The transmission method according to claim 7, wherein the number of bits of the transmission signals and the number of bits of the image signals are the same and when the differential value between the
$${[ ( {\sum }_{i = 1}^{j} {k}_{i} ) - {k}_{j} + {y}_{j} ]}^{th}$$
image signal and the
$${[ ( {\sum }_{i = 1}^{j} {k}_{i} ) - {k}_{j} + {y}_{j} - 1 ]}^{th}$$
image signal is a negative value, the
$${[ ( {\sum }_{i = 1}^{j} {k}_{i} ) - {k}_{j} + {y}_{j} ]}^{th}$$
transmission signal uses a 2's complement of the differential value to represent each bit thereof.

10. The transmission method according to claim 7, wherein k_{i′} is equal to k_{i′+1} and i′ is an integer from 1 to (x−1).

11. The transmission method according to claim 7, wherein each image signal comprises a red image signal, a green image signal, and a blue image signal, and each transmission signal comprises a red transmission signal, a green transmission signal, and a blue transmission signal.

12. A transmission interface, used in an LCD, wherein the LCD comprises at least one source driver, processing x transmission signals, x is an integer greater than 1, and the transmission interface comprises:an encoding device, receiving x image signals, encoding the first image signal of the x image signals as the first transmission signal of the x transmission signals, and encoding the differential value between the y^{th} image signal and the (y−1)^{th} image signal of the x image signals as the y^{th} transmission signal of the x transmission signals, so as to generate x transmission signals,
wherein y is an integer from 2 to x.

13. The transmission interface according to claim 12, further comprising:
a decoding device, coupled to the encoding device, receiving the x transmission signals from the encoding device, decoding the x transmission signals, and transmitting the x transmission signals after decoding to the source driver.

14. The transmission interface according to claim 12, wherein the number of bits of the transmission signals and the number of bits of the image signals are the same and when the differential value between the y^{th} image signal and the (y−1)^{th} image signal is a negative value, the y^{th} transmission signal uses a 2's complement of the differential value to represent each bit thereof.

15. The transmission interface according to claim 12, wherein each image signal comprises a red image signal, a green image signal, and a blue image signal, and each transmission signal comprises a red transmission signal, a green transmission signal, and a blue transmission signal.

16. A transmission method, used in an LCD, wherein the LCD comprises at least one source driver, processing x transmission signals, x is an integer greater than 1, and the transmission interface comprises:
receiving x image signals;
encoding the first image signal of the x image signals as the first transmission signal of the x transmission signals; and
encoding the differential value between the y^{th} image signal and the (y−1)^{th} image signal of the x image signals as the y^{th} transmission signal of the x transmission signals,
wherein y is an integer from 2 to x.

17. The transmission method according to claim 16, further comprising:
decoding the x transmission signals and transmitting the x transmission signals after decoding to the source driver after decoding.

18. The transmission method according to claim 16, wherein the number of bits of the transmission signals and the number of bits of the image signals are the same and when the differential value between the y^{th} image signal and the (y−1)^{th} image signal is a negative value, the y^{th} transmission signal uses a 2's complement of the differential value to represent each bit thereof.

19. The transmission method according to claim 16, wherein each image signal comprises a red image signal, a green image signal, and a blue image signal, and each transmission signal comprises a red transmission signal, a green transmission signal, and a blue transmission signal.

20. A transmission method, used in an LCD, wherein the LCD comprises at least one source driver, processing at least two transmission signals, and the transmission interface, the transmission method comprises:
receiving at least two image signals;
encoding the first image signal of the two image signals as the first transmission signal of the two transmission signals; and
encoding the differential value between the first image signal and the second image signal of the two image signals as the second transmission signal of the two transmission signals.
